(19) United States
(12) Patent Application Publication
(10) Pub. No.: US 2006/0156794 A1
(43) Pub. Date: Jul. 20, 2006

(54) Apparatus and method for measuring gap bulk density of a catalytic converter support mat

(76) Inventors: Tobin L. Horn, Tekonsha, MI (US); Scott J. Wheeler, Litchfield, MI (US)

Correspondence Address: HARNESS, DICKEY & PIERCE, P.L.C., P.O. BOX 828, BLOOMFIELD HILLS, MI, 48303, US

(21) Appl. No.: 11/013,095

(22) Filed: Dec. 15, 2004

(51) Int. Cl. G01N 9/00; B23Q 17/00

(52) U.S. Cl. 73/32 R; 29/890; 29/407.04; 29/407.05

(57) ABSTRACT

Gap bulk density (GBD) of a support mat surrounding a catalyst substrate in a catalytic converter is calculated using an average gap width optically determined by a camera system. Mat weight determined at an assembly station is bar coded and placed in a bar code label attached to the converter under test. A programmable controller calculates an average gap width from a plurality of camera readings. GBD is then calculated using mat weight and dimensions, and the GBD is compared to an acceptable range to determine pass/failure of the converter.

### FIELD OF THE INVENTION

The present invention relates to testing catalytic converters for proper assembly. More particularly, the invention concerns determining the gap bulk density of a support mat surrounding a catalyst in a converter housed in an outer casing.

### BACKGROUND OF THE INVENTION

Many catalytic converters comprise a substrate or cartridge utilizing a structure bearing the catalytic compounds surrounded by a support mat interfacing the substrate and an outer casing or shell of the converter. In applying force to the mat by the enclosing outer shell or converter casing, two objectives are somewhat at odds. On the one hand, the pressure on the support mat must be sufficient to assure the substrate will be held in place under rather severe conditions of temperature and vibration. On the other hand, the pressure on the support mat must be less than that which would cause cracking or other damage to the substrate.

One characterization of a compressed support mat in a catalytic converter which may used to determine whether proper pressure is applied to the mat is “gap bulk density”, or GBD. GBD basically is mat weight per unit volume of mat, or mat weight divided by the product of mat area (substantially constant) times the gap width between the outer casing and substrate, or mat width. GBD is typically expressed in grams per cubic centimeter.

Known automated GBD measuring systems use indirect calculations, or assumptions, to estimate gap width. Other systems, such as that disclosed in U.S. Pat. No. 6,501,042, calculate GBD during actual assembly of the converter and attempt to adaptively alter the outer casing and the substrate to achieve a desired GBD. However, this approach assumes no change to the mat density shortly after assembly and can lead to erroneous conclusions as to whether proper mat pressure will be applied in the final assembled product.

Hence, there is a need in the art for an automated, yet economic, apparatus and method for measuring and evaluating GBD after the converter outer casing has been applied to the converter substrate/mat combination.

### SUMMARY OF THE INVENTION

Accordingly, apparatus for determining gap bulk density in a catalytic converter having an outer casing containing a converter substrate at least partially surrounded by a support mat of preselected surface area filling a gap between the outer casing and the substrate includes at least one camera for capturing an optical image of the gap. A casing positioning element places the outer casing in a predetermined orientation with respect to the at least one camera. A programmable controller is coupled to the casing positioning element and to the at least one camera and a reader is coupled to the programmable controller and operative to read an indication of mat weight and to communicate the indication to the programmable controller. The programmable controller is operative to calculate bulk gap density of the support mat as a function of gap width determined from the optical image, the preselected surface area of the support mat and the weight of the support mat derived from the communicated indication.

In another aspect of the invention, apparatus for determining gap bulk density in a catalytic converter having a cylindrical outer casing containing a converter substrate at least partially surrounded by a support mat of preselected surface area filling a gap between the outer casing and the substrate includes first and second cameras for capturing images of the gap at first and second respective opposite ends of the outer casing. A casing positioner includes a plurality of rollers positioned for abutting receipt of a converter under test, the plurality of rollers coupled to a slide mechanism for translating movement of the rollers and converter under test. A programmable controller is coupled to the casing positioner and to the first and second cameras. A scanner is coupled to the programmable controller and operative to scan an indication of weight of the support mat and to communicate the indication to the programmable controller. The programmable controller is operative to cause the casing positioner to move the converter under test from a first loading position to a gap measurement position between the first and second cameras and to cause the casing positioner rollers to rotate the outer casing to a plurality of positions and to enable the first and second cameras to capture a like plurality of gap images at first and second ends of the casing at each position. The controller is further operative to calculate an average gap width from all of the gap images and to calculate bulk gap density of the support mat using the average gap width, the scanned mat weight and the predetermined mat surface area.

In yet another aspect of the invention, a method for determining gap bulk density of a support mat of known surface area and at least partially surrounding a substrate in a catalytic converter and filling a gap between an outer casing of the converter and the substrate includes placing an indication of weight of the support mat on an outer surface of the outer casing, positioning the outer casing for reading the indication of weight, positioning the outer casing relative to at least one camera for optically determining width of the gap, and determining gap bulk density as a function of gap width, support mat surface area and support mat weight.

### BRIEF DESCRIPTION OF THE DRAWINGS

The objects and features of the invention will become apparent from a reading of a detailed description taken in conjunction with the drawing, in which:

FIG. 1 presents a front perspective view of a GBD testing station arranged in accordance with the principles of the invention;

FIG. 2 presents details of a display portion of the test stand of FIG. 1;

FIG. 3 is a partial perspective view through access aperture 106 of FIG. 1 of one of the gap measuring cameras;

FIG. 4 is a perspective view of a GBD measurement camera mounting arrangement of the test station of FIG. 1; and

FIG. 5 is a flow chart setting forth the method of the invention.

### DETAILED DESCRIPTION

The description of the invention is merely exemplary in nature and thus, variations that do not depart from the gist of the invention are intended to be within the scope of the invention. Such variations are not to be regarded as a departure from the spirit and scope of the invention.

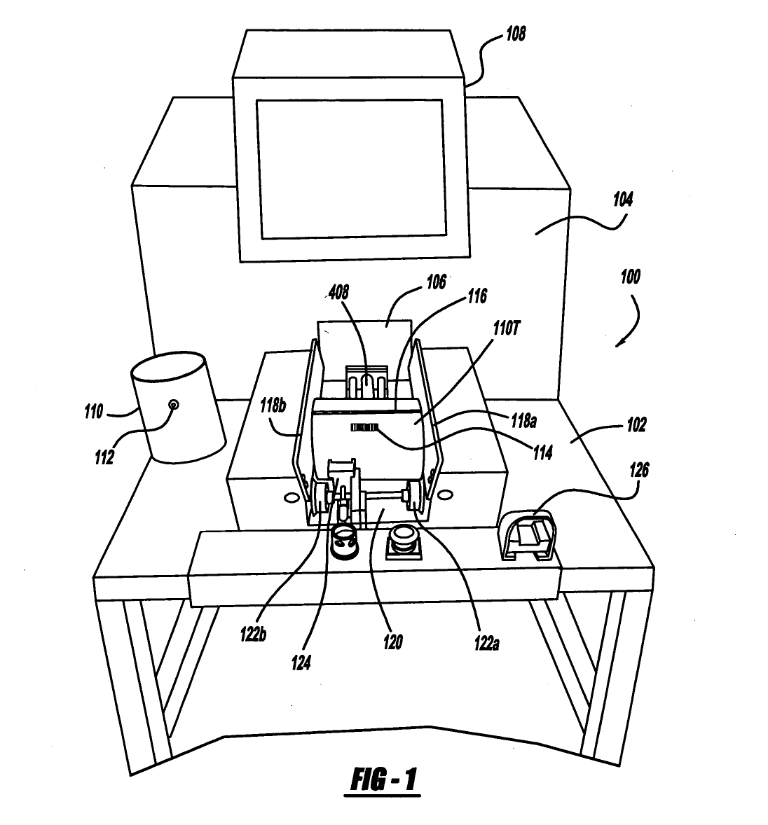

With reference to FIG. 1, GBD testing station 100 is principally comprised of a station base section 102 and a station optical measurement section 104 extending vertically from base 102. Access aperture 106 in section 104 is provided for movement of a converter under test therethrough to a gap measuring station located between first and second cameras to be discussed later.

Test station display 108 is mounted to section 104 and provides a variety of information to the test stand operator, the details of which will be set forth in a later section of this description.

A typical converter outer casing 110 is shown resting on station base 102 at the left side thereof in FIG. 1. Also shown on outer casing 110 is a locater tab 112 which will be used as explained below.

A converter under test 110T is shown positioned with its opposing ends in abutting relationship with guide plates 118a and 118b. Converter 110T carries in the vicinity of its outer casing pinch point 116 a bar coded label 114 which carries an indication of the weight of the support mat contained within converter 110T. This weight is typically determined at an assembly station, not shown, wherein the support mat is weighed prior to the assembly of the mat and substrate within casing 110T.

After an operator places the converter under test 110T in its position between guide plates 118a, b as shown in FIG. 1, the converter is rotated until a locator tab detector, such as a proximity switch 124 determines that the converter casing is properly oriented on runway 120 which houses a slide mechanism 408.

When the converter under test has been properly so oriented, the operator fetches a handheld bar code scanner from scanner docketing port 126 and scans the mat weight indicator into a programmable controller resident in, for example, section 104 of the test stand.

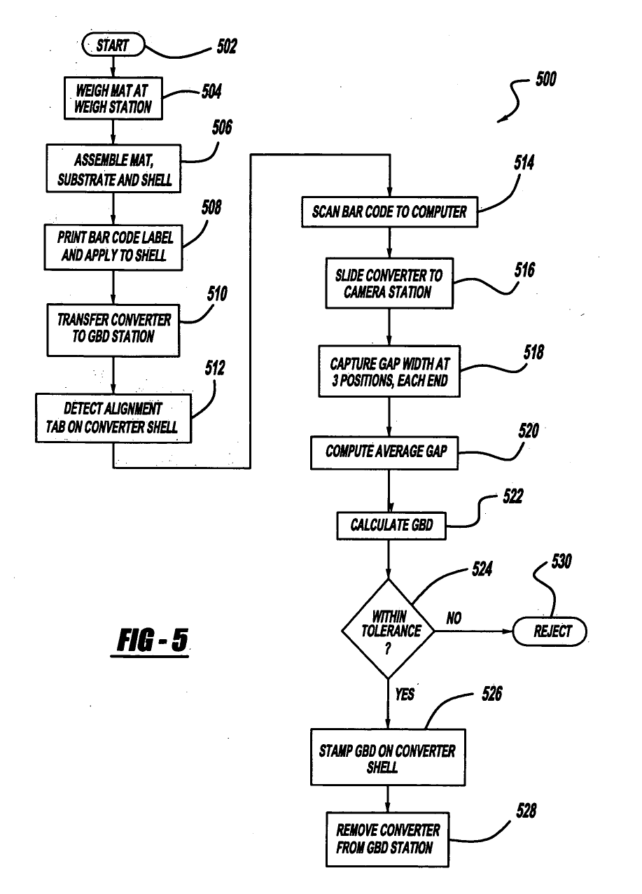

The converter under test 110T rests upon four casters or rollers, two of which are shown in FIG. 1 as 122a and 122b. Slide 408 is operative to translate the converter under test 110T from its position shown in FIG. 1 rearwardly along runway 120 and slide 408 through aperture 106 to a position wherein the bottom gaps at either end of converter under test 110T face first and second cameras mounted within section 104 (see, for example, FIG. 4).

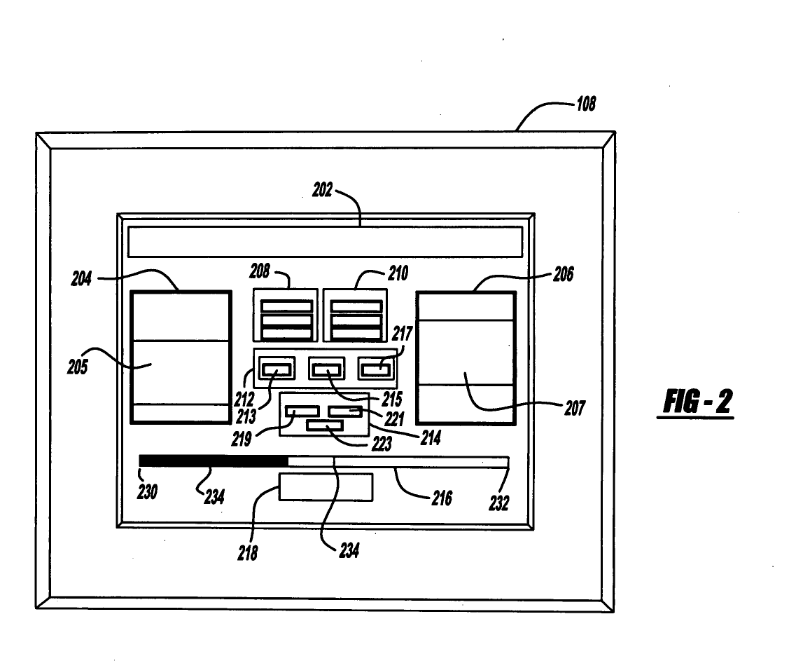

Turning now to FIG. 2, details of the operator display are set forth. Display 108 includes various display panels positioned thereon. Display 202 is a sequential operator message display which sequentially alerts the user to which part of the GBD determination process is underway. For example, display 202 could sequentially display messages such as:

INSERT PART IN SLIDE

POSITION PART PER PROXIMITY SWITCH

SCAN BARCODE

REMOVE PART

Displays 204 and 206 present respectively the left and right camera image being captured. Areas 205 and 207 therefore respectively represent the gap between the converter's outer casing and its converter substrate at the left and right end of the converter cylinder.

The three rectangular areas shown in display 208 present three gap widths derived from three measurements of the gap via the left side camera. Similarly, in display area 210, three measurements of the gap derived from the right camera are set forth. When the converter under test 110T has been moved rearwardly through aperture 106 of FIG. 1 to a position between cameras 302 and 402 of FIG. 4, casters 122a, b and 122c, d (not specifically shown) are rotated, for example, via a servo drive, such that the converter outer casing presents a plurality of gap positions for inspection by the left and right cameras 402 and 302, respectively, of FIG. 4. In a preferred embodiment, three different gap images are captured at each end of the converter under test leading to the six measurements displayed in the displays 208 and 210 of FIG. 2.

Display area 212 contains calculation data—specifically, at display area 213 the mat weight scanned from the barcode label is presented, at display area 215, the average gap width calculated from the six camera measurements is displayed, and at display area 217, the GBD calculated using the average gap width is set forth.

Display area 214 is a part tracking display wherein at section 219 the number of converters that have passed the GBD test is set forth, while in display area 221 the number of converters which have failed the GBD test are accumulated. 223 represents a counter reset switch.

Display 216 is a bar graph-type readout showing the latest GBD result relative to acceptable GBD range limits—i.e., a tolerance range—between the minimum acceptable GBD at 230 (e.g., 0.83) and a maximum acceptable GBD 232 (e.g., 0.97), with a “perfect” GBD of 0.9, for example, being located at the midpoint 234 of bar display 216. Shaded region 234 represents the actual GBD calculated for the converter under test.

Finally, 218 represents a switch for manually sequencing the test station through its operating sequence.

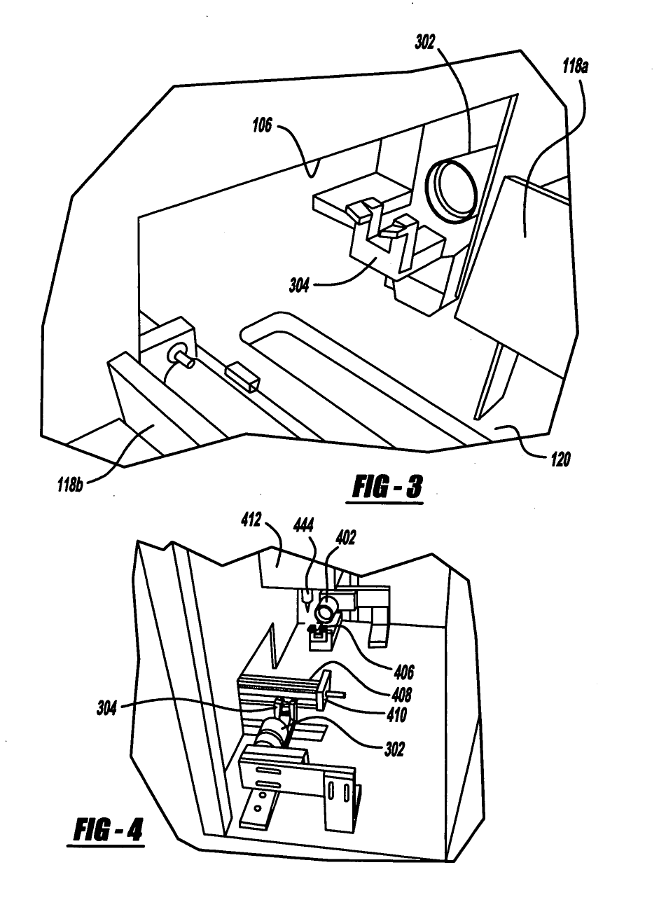

With reference to FIGS. 3 and 4, a converter under test will come to rest along slide 408 at stop member 410 such that its end sections will rest on fixtures 304 and 406 thereby presenting the gap at the bottom of the cylinder to each of cameras 302 and 402.

Any converter under test whose calculated GBD is determined to fall within the acceptable tolerance range will then be given an indication of passing the test via pin stamping unit 412 carrying a stamping stylus 444. Using stylus 444, the test stand will emboss the actual calculated GBD just derived from the camera measurements onto the outer casing of the converter under test 110T.

With reference to FIG. 5, flow chart 500 includes steps usable in accordance with the principles of the invention as they apply to a process or method.

Starting at bubble 502 the support mat is weighed at a weigh station at step 504, the weigh station typically being associated with an assembly station for the converters to be subsequently tested.

Next, at step 506 the mat, substrate and shell are assembled resulting in a converter having an outer casing surrounding a mat which in turn surrounds the substrate.

At 508, a barcode label is printed in accordance with the weighing results in step 504 and the label is applied to the outer casing of the converter to be tested.

At 510 converter under test 110T is transferred to the GBD station 100 of FIG. 1.

At step 512, the converter is properly aligned on the casters associated with slide 408 of FIG. 1 as indicated by a proximity switch which detects the presence of locator tab 112.

Next, upon cue from the display 108 of FIG. 1, the operator fetches a handheld barcode scanner from scanner docking port 126 of FIG. 1 and scans the mat weight indicated in the barcode into the programmable controller at the test stand.

At step 516, the converter 110T is translated along slide 408 to the camera station located rearward of access window 106 in FIG. 1.

At step 518, three gap images are captured at opposite ends of the converter, the converter being rotated among the three positions by rollers or casters 122 of FIG. 1.

At step 520, the average gap width is calculated by programmable controller of the test stand and at step 522, the gap bulk density is calculated using the average gap width.

At decision block 524, the programmable controller determines whether the calculated GBD is within the acceptable tolerance range. If not, a reject indication is given at the display and the reject part count is incremented at step 530. The rejected part is then removed from the test stand.

If the GBD is within tolerance at decision block 524, then the calculated GBD is stamped or embossed on the converter shell at step 526, the passing parts counter is incremented and the converter is removed from the test stand at step 528.

As noted above, the description of the invention is merely exemplary in nature and the true scope and spirit of the invention are to be determined from an appropriate interpretation of the appended claims.

What is claimed is:

1. Apparatus for determining gap bulk density in a catalytic converter having an outer casing containing a converter substrate at least partially surrounded by a support mat of preselected surface area filling a gap between the outer casing and the substrate, the apparatus comprising:
at least one camera for capturing an optical image of the gap;
a casing positioning element for placing the outer casing in a predetermined orientation with respect to the at least one camera;
a programmable controller coupled to the casing positioning element and to the at least one camera; and
a reader coupled to the programmable controller and operative to read an indication of weight of the support mat and to communicate the indication to the programmable controller;
the programmable controller operative to calculate bulk gap density of the support mat as a function of gap width determined from the optical image, the preselected surface area of the support mat and the weight of the support mat derived from the communicated indication.

2. The apparatus of claim 1 wherein the programmable controller is further operative to determine if the calculated gap bulk density falls within a tolerance range and to generate a corresponding pass/fail indication.

3. The apparatus of claim 1 wherein the recorder comprises a barcode scanner and the indication of weight comprises a bar coded label coupled to the outer casing.

4. The apparatus of claim 2 wherein the corresponding pass/fail indication comprises an indication of the calculated gap bulk density whenever the calculated gap bulk density falls within the tolerance range.

5. The apparatus of claim 1 wherein the casing positioning element under direction of the programmable controller places the outer casing in a plurality of predetermined orientations with respect to the at least one camera, the at least one camera captures a corresponding plurality of gap images, and the programmable controller calculates an average gap width from the plurality of images.

6. Apparatus for determining gap bulk density in a catalytic converter having a cylindrical outer casing containing a converter substrate at least partially surrounded by a support mat of preselected surface area filling a gap between the outer casing and the substrate, the apparatus comprising:
first and second cameras for capturing images of the gap at first and second respective opposite ends of the outer casing;
a casing positioner including a plurality of rollers positioned for abutting receipt of a converter under test, the plurality of rollers coupled to a slide mechanism for translating movement of the rollers and converter under test;
a programmable controller coupled to the casing positioner and to the first and second cameras; and
a scanner coupled to the programmable controller and operative to scan an indication of weight of the support mat and to communicate the indication to the programmable controller;
the programmable controller operative to cause the casing positioner to move the converter under test from a first loading position to a gap measurement position between the first and second cameras and to cause the casing positioner rollers to rotate the outer casing to a plurality of positions and to enable the first and second cameras to capture like pluralities of gap images at first and second ends of the casing at each position; the controller further operative to calculate an average gap width from all of the gap images and to calculate bulk gap density of the support mat using the average gap width, the scanned mat weight and the predetermined mat surface area.

7. The apparatus of claim 6 wherein the programmable controller causes the casing positioner rollers to position the gap at three equally angularly spaced locations thereof with respect to the first and second cameras.

8. The apparatus of claim 6 wherein the programmable controller is further operative to determine if the calculated gap bulk density falls within a tolerance range and to generate a corresponding indication whenever the calculated gap bulk density is within the tolerance range.

9. The apparatus of claim 8 wherein the corresponding indication comprises embossing the calculated gap bulk density on the outer casing.

10. The apparatus of claim 8 wherein the scanner comprises a bar code scanner and the indication of weight comprises a bar coded label affixed to the outer casing.

11. The apparatus of claim 8 further comprising a detector switch for determining whether the converter under test has been placed properly in the first loading position.

12. The apparatus of claim 11 wherein the detector switch comprises a limit switch for detecting a locating tab affixed to the outer casing.

13. A method for determining gap bulk density of a support mat of known surface area and at least partially surrounding a substrate in a catalytic converter and filling a gap between an outer casing of the converter and the substrate, the method comprising:
placing an indication of weight of the support mat on an outer surface of the outer casing;
positioning the outer casing for reading the indication of weight;
positioning the outer casing relative to at least one camera for optically determining width of the gap; and
determining gap bulk density as a function of gap width, support mat surface area and support mat weight.

14. The method of claim 13 further comprising:
determining if the gap bulk density falls within a tolerance range.

15. The method of claim 14 further comprising:
placing an indication of the gap bulk density on the outer casing whenever the gap bulk density falls within the tolerance range.

16. The method of claim 13 further comprising:
positioning the outer casing in a plurality of orientations with respect to the at least one camera;
optically determining a like plurality of the gap widths, one at each of the plurality of orientations;
determining an average gap width from the plurality of gap widths; and
determining the gap bulk density using the average gap width.
